(19) United States
(12) Patent Application Publication
(10) Pub. No.: US 2018/0165180 A1
(43) Pub. Date: Jun. 14, 2018

(54) Batch File Creation Service

(71) Applicant: Bank of America Corporation, Charlotte, NC (US)

(72) Inventors: Michele D. Savidge, Port Deposit, MD (US); William F. Kammerer, Newark, DE (US); Deepak M. Agrawal, Solapur Maharashtra (IN); Frank Chou, Newark, DE (US); Sandra Lane, Wilmington, DE (US); Pam Adams, Russell Ontario (CA); Chris Bairstow, Newark, DE (US)

(21) Appl. No.: 15/378,953

(22) Filed: Dec. 14, 2016

(51) Int. Cl. G06F 11/36; G06F 17/30

(52) U.S. Cl. CPC G06F 11/3684; G06F 11/3664; G06F 17/30076; G06F 17/30091; G06F 11/3688

(57) ABSTRACT

A software testing computing system may include a batch file creation computing device, a user interface device communicatively coupled to the file creation computing device and a software testing computing system communicatively coupled to the batch file creation computing device to receive a batch file including a test case for use in testing a software application or service. The batch file creation computing device may receive criteria for testing a software application, generate a data structure formatted corresponding to a software test case associated with the criteria, retrieve and store in the data structure a first data set from a first data repository, merge, a second data set retrieved from a second data repository with the first data set stored in the data structure, and generate a batch test file using the data structure storing a merged data set including the first data set merged with the second data set.

### FIELD OF THE INVENTION

Various aspects of the disclosure relate to computing systems for use in testing of software applications. More specifically, aspects of the disclosure relate to creating a batch file from two or more data sources to create a randomized test case in response to a user input and converting the batch file to a useable format corresponding to requirements of the computing system.

### BACKGROUND OF THE INVENTION

During the development of software, testing of the software is a major component of developing a suitable software product. Due to more aggressive schedules, performing necessary testing of various configurations and possible user interactions can be difficult to perform due to the difficulty in timely generation of test cases using a variety of user settings and/or different combinations of products and/or services that the users may desire. Because of this, software applications may be tested based on limited test cases. For example, in an attempt to increase the speed of testing, (e.g., a manual testing process and/or automated testing process), the software testing computing systems may rely on a small handful of test cases, which may fail to test a large portion of the software functionality. In addition, manual creation of test files may be performed over a long period of time (e.g., days, weeks, e.g.,), thus limiting the functionality that can be tested, leading to low confidence in the testing results and, in some cases, a higher proportion of software defects being found after release of the software product and/or service. With limited test cases being available, the software testing process may be more time consuming and less accurate than desired. As such, a need has been recognized for a batch file creation service capable of efficiently generating and managing batch files defining different test scenarios and including randomized test data from a plurality of data sources accessible via a distributed computing network.

### SUMMARY OF THE INVENTION

Aspects of the disclosure provide effective, efficient, scalable, and convenient technical solutions that address and overcome the technical problems associated with generating batch files using randomized data from two or more data sources for use in testing of software applications. In particular, one or more aspects of the disclosure may provide a software testing computing system including a batch file creation computing device, a user interface device communicatively coupled to the file creation computing device and a software testing computing system communicatively coupled to the batch file creation computing device to receive a batch file including a test case for use in testing a software application or service. The batch file creation computing device may receive criteria for testing a software application, generate a data structure formatted corresponding to a software test case associated with the criteria, retrieve and store in the data structure a first data set from a first data repository, merge, a second data set retrieved from a second data repository with the first data set stored in the data structure, and generate a batch test file using the data structure storing a merged data set including the first data set merged with the second data set. These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 shows an illustrative distributed computing system to for testing software applications according to aspects of this disclosure;

FIG. 2 shows an illustrative method for user interaction with a distributed software testing computing system according to aspects of this disclosure;

FIG. 3 shows an illustrative method to generate a batch file for testing software application using randomized data stored in a plurality of data repositories according to aspects of this disclosure;

FIG. 4 shows an illustrative method of converting a file from a first format to a second format according to aspects of this disclosure; and

FIGS. 5 and 6 show illustrative user interface screens to initiate an action by the batch file creation service according to aspects of this disclosure.

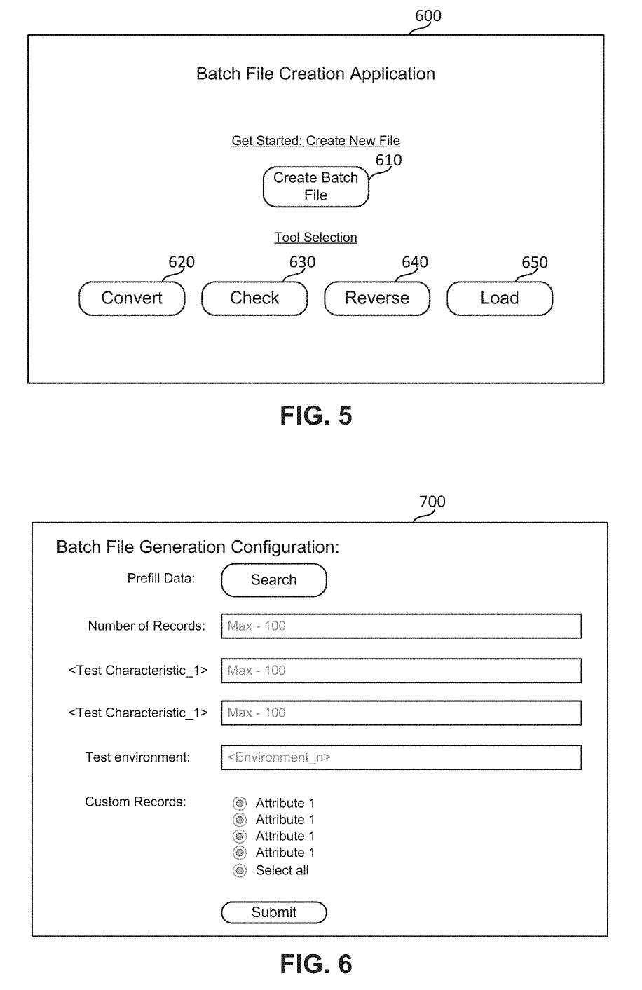

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure. The disclosure is capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. For example, the use of “including” and “comprising” and variations thereof is meant to encompass the items listed thereafter and equivalents thereof as well as additional items and equivalents thereof, and the use of the terms “mounted,” “connected,” “coupled,” “positioned,” “engaged” and similar terms, is meant to include both direct and indirect mounting, connecting, coupling, positioning and engaging.

It is noted that various connections between elements are discussed in the following description. It is noted that these connections are general and, unless specified otherwise, may be direct or indirect, wired or wireless, and that the specification is not intended to be limiting in this respect.

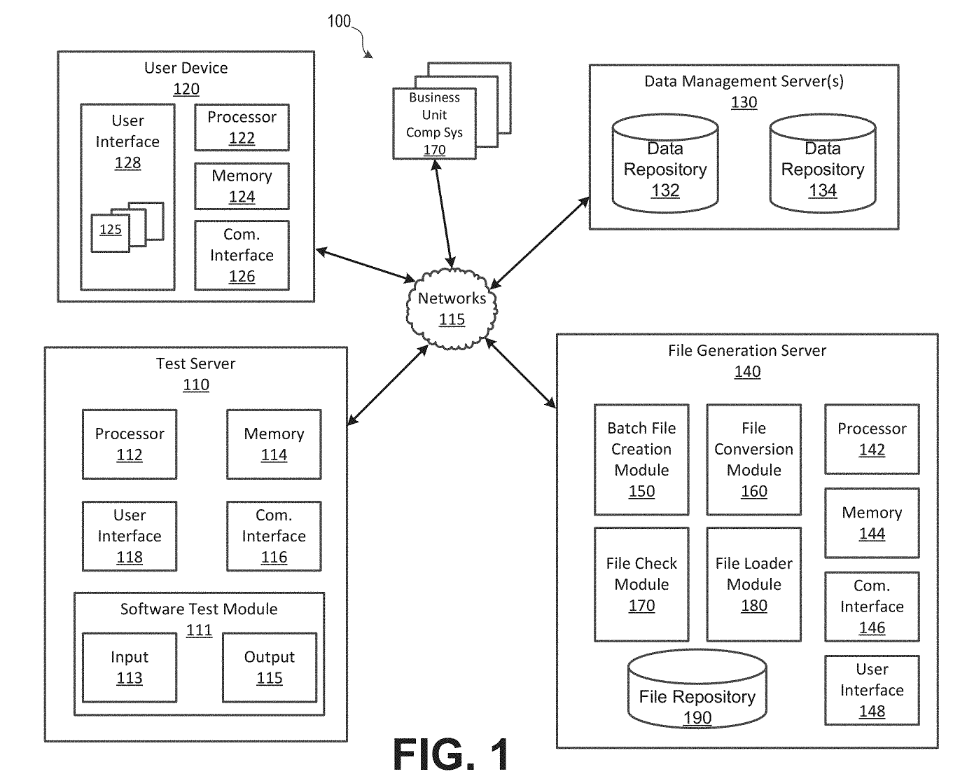

FIG. 1 shows an illustrative distributed computing system, such as a distributed computing system 100 configured to provide a batch file creation service to for testing software applications according to aspects of this disclosure. The distributed computing system 100 may include multiple computing devices and/or computing systems communicatively connected via a network 115. The computing system may include a test server 110, a user device 120, one or more data management servers 130, a file generation server 140 and/or one or more computing systems providing products and/or services offered by an organization (e.g., the business unit computing systems 170.

The distributed computing system 100 may include one or more computing devices (e.g., the test server 110) communicatively coupled to the network 115 and configured to perform testing of functionality provided via one or more software applications. In the illustrative example of FIG. 1, the test server 110 may include a processor 112, one or more non-transitory memory devices, a communication interface 116 to facilitate communication via the network, a user interface 118, and/or a software test module 111 that may include an input 113 for receiving one or more test cases (e.g., batch files) for use in testing the software application and/or service and an output 115 for outputting a result (e.g., a report, an error listing, and the like) of one or more tests performed based on the information provided in the test cases. In some cases, the software test module 111 may be fully automated and perform necessary testing of the software application and/or service by processing a test case provided in a batch file with little or no human input, may be a manual process, where a user initiates at least a portion of the testing process based on the batch files, or may include a combination of manual tests performed by a human operator and automated testing processes performed by a software testing application process by the software test module 111 such as by running one or more scripts. For example, by using testing scripts processing a test case defined by an input batch file, the software test module 111 may emulate how a user will use a software product, interact with a computing system, and/or use a provided service (e.g., an Internet based service). Use of the batch file based test cases with or without test scripts helps to lessen the need for manually inputting various items into the software thus increasing the throughput of the testing process, increasing the number of test cases that may be tested in a limited testing window, increasing repeatability of tests, and providing for a more efficient review of the testing results as an increased number of test cases run during testing allows the software testing module 111 to more efficiently identify software defects and/or narrow down a cause of the identified software defects.

FIG. 1 illustrates one example of a network architecture and data processing device that may be used to implement one or more illustrative aspects. Various network nodes F may be interconnected via a wide area network (WAN), (e.g., the network 115), such as the Internet. Other networks may also or alternatively be used, including private intranets, corporate networks, LANs, wireless networks, personal networks (PAN), and the like. The network 115 is for illustration purposes and may be replaced with fewer or additional computer networks. A local area network (LAN) may have one or more of any known LAN topology and may use one or more of a variety of different protocols, such as Ethernet. Devices shown and not shown may be connected to one or more networks via twisted pair wires, coaxial cable, fiber optics, radio waves or other communication media. For example, the above connections can be made via the internet, bluetooth, WiFi, infrared, or any other known method of wireless transmission.

The user device 120 may include a processor 122, one or more memory devices 124, a communication interface 126, and a user interface 128 which may include one or more user input/output devices (e.g., a pointing device, a touch screen, a keyboard, and the like) and a display for displaying one or more user interface screens 125. In some cases, the user device 120 may be a specially programmed computing device performing functionality to facilitate interaction with the batch file creation service. In some cases, the user device 120 may access functionality of the batch file creation service through networked functionality (e.g., internet browser screens, specially programmed user interface programs, and the like). In either case, a user may be presented with one or more user interface screens to initiate actions performed by the batch file creation service and/or view outputs resulting from different functionalities provided by the batch file creation service. In some cases, one or more of the user interface screens 125 may facilitate user interaction with the test server 110 (e.g., the software test module 111), the data management server(s) 130 and/or the file generations server 140. The user interface screens will be discussed in greater detail below.

In an illustrative example, the user device 120 may include one or more personal computers such as desktops, laptops, notebooks, mobile telephones or smartphones with applications and other functionality, a handheld device with Wi-Fi or other wireless connectivity (e.g., wireless enabled tablets, tablet computers, PDAs, and the like), displays with built-in or external memories and processors, and the like that may process instructions to perform and/or interact with at least a portion of the batch file creation service functionality. These devices can be enabled to communicate with wireless access points which in one example can be a series of cellular towers hosted by a service provider. Additionally, the wireless access points may be Wi-Fi (e.g., compatible with IEEE 802.11a/b/g/ and the like wireless communication standards) connections and the computing devices may obtain access to the Internet at these connections.

The data management server(s) 130 may comprise one or more network connected computing devices configured to store and/or manage access to information stored in one or more data repositories (e.g., data repository 132, data repository 134, and the like). In some cases, one or more data repositories managed by the data management server 130 (e.g., the data repository 132, the data repository 134, and the like) may be configured as a big-data data repository such as a scalable non-SQL database having low latency and high throughput, as a relational data base, an unstructured data base, an SQL database, and/or the like. In some cases, information stored in a first data repository 132 and the second data repository may include information that may be used in building a batch file comprising a test case. For example, the first data repository 132 may include information corresponding to one or more simulated individuals, such as customers of an organization. Such information may include data similar to user information that may be processed by the software application or service under test, such as a name, address, a simulated account number, a phone number, an email address, simulated health information, simulated financial information, and/or the like. In some cases, a second data repository may include information corresponding to one or more products and/or services provided by the organization, such as product information, marketing information, advertising information, and/or the like.

In an illustrative example, a software application under test may be used to process user requests and/or applications for a business-provided product in response to a received marketing offer. For example, a business organization such as a financial institution may provide credit card services based on characteristics of the customer who has applied for the credit card product. In some cases, the business organization may send multiple marketing offers, where each of the marketing offers are based on characteristics of the individual receiving a particular offer. As such, a software application and/or service to process user responses based on such offers may be complex to be able to handle each targeted offer. The software application or service may be required to easily and efficiently handle user requests based on different information and, to ensure proper operation, the testing regimen processed by the software test module 111 may include one or more batch files configured with validated information capable of simulating the number and variety of responses that may be encountered once the application is released. The test cases included in the batch file may be generated based on information stored in a first data repository (e.g., data repository 132) that is modified and/or augmented based on information stored in a second data repository (e.g., data repository 134. In the illustrative example, the first data repository 132 may include information corresponding to simulated customers, the information including characteristics corresponding to individuals that may use the software application or service provided by the organization. For example, the first data repository 132 may include customer information including names, demographic information (e.g., age, gender, race, educational information, familial information, and the like), contact information (e.g., address(es), phone number(s), email address(es), and/or the like), financial information (e.g., account numbers, balance information, holdings information, and the like) and geographic information, and/or other such information. The second data repository (e.g., the data repository 134) may be used to store information corresponding to a product or service to be marketed to individuals, such as marketing information, sales information, product information, service information, and/or the like. This information may include information about the particular product and/or service may be offered to individuals having particular characteristics (e.g., a geographical location of a residence or place of business, an age of an individual, credit history information, financial information, employment history, and/or the like).

In an illustrative example, the first data repository 132 may be populated with a number of test records (e.g., about 100 test records, about 1000 test records, about 10,000 test records, and the like) that are unique and look like production customers (e.g., simulated customers) of one or more products and/or services offered by the organization. The second data repository 134 may be populated with a number of different test records (e.g., about 100 test records, about 1000 test records, about 10,000 test records, about 20,000 test records, and the like) that may correspond to marketing offers targeted towards the different production customers of the organization based on characteristics associated with the production customers. In some cases, a user, such a user of the user device 120, may access a user interface screen that allows the user to select characteristics of the file, such as a number of simulated customers to include in the test case batch file. This information may be communicated to the file generation server 140 that may use the information received through the user interface of the user device 120 to generate a test case batch file with randomized simulated customers extracted from the data repository 132 and matched with random marketing offers stored in the second data repository 134. This file may then be edited, modified and/or formatted to be used by the software test module 111 of the test server 110. In some cases, the batch file may be loaded via the input 113 of the software test module 111 to be tested, when converted to the correct format, or may be edited after creation (or formatting) to modify characteristics so that a particular test condition may be tested.

The business unit computing systems 170 may correspond to one or more computing systems that may belong to a business organization, an education institution, a governmental agency, and the like. In an illustrative example, a business organization computing system may include a data management server that may coordinate communication of information over the network 115 between difference computing systems and/or computing devices The data management server may be communicatively coupled to one or more other computing systems of the organization (e.g., business organization, education institution, governmental agency, and the like) and/or third party computing systems. For example, the data management server may be communicatively coupled, either directly or indirectly (e.g., via one or more computing devices such as routers, servers, and the like) to the one or more business unit computing systems 170. In some cases, the business unit computing systems may be configured to provide specific functionality, such as managing a user account and/or providing specific products and/or services to a user. In some cases, the business unit computing systems may store information associated with one or more products and/or services provided by the organization, such as via a software application or service. In such cases, updates to different software applications and/or services provided by the organization may require testing based on data stored in a data repository associated with the one or more business unit computing systems 170, which may be accessible, such as via a secure connection, to the batch file creation service. In cases in which sensitive and/or non-public information may be processed by the software application and/or service under test, such data may be scrubbed and/or screened from access by the batch file creation service such that substitute information not associated with the private or non-public information, may be substituted so that data security is maintained. For example, information may be stored in a different data repository may store information representative of the type of information that may be private or non-public (e.g., account numbers, user names, user passwords, and the like) but would not be associated with actual non-public or private information. In some cases, the business unit computing systems 170 may communicate information to be tested via the network 115, such as by populating one or more data repositories with test data not associated with any particular real user (e.g., simulated data, scrubbed data, and the like).

In some cases, the file generation server 140 may include a processor 142, one or more memory devices 144, a communication interface communicatively coupled to the network(s) 115, a user interface 148 that may be accessible locally to the file generation server 140, or remotely via a network connection. The illustrative file generation server 140 may store instructions in the memory 144 that, when executed by the processor 142 to provide specially programmed functionality including a batch file creation module 150, a file conversion module 160, a file check module 170, and/or a file loader module 180, and the like. The file generation server 140 may also include a file repository 190 that may store a record of test cases received from the user device 120 via the network 115, a number of files generated by the file generation server 140 and/or the like.

In some cases, the batch file creation module 150, the file conversion module 160, the file check module 170 and/or the file loader module 180, along with the file repository 190 of the file generation server 140 and the data repository 132 and/or the data repository 134 may allow for increased efficiency of a software testing process utilizing the test server 110. This efficiency gain may be facilitated by the use of the batch file creation service has allowed testing of applications to be performed in near real time to the generation of the version of software to be tested rather than waiting a number of days or weeks to generate a test case file. Instead, the batch file creation service allows for testing of the file to begin within minutes (e.g., about 2 minutes, about 4 minutes, about 5 minutes, and the like) of defining test case parameters. Additionally, the randomization functionality of the batch file creation service allows for creation of use cases with greater variety of data combinations than would normally have been created in a manual or partially manual process. As such, the batch file creation service allows the software test module 111 to test a wider variety of use cases, resulting in more thorough and accurate tests that find a greater percentage of software defects allowing for more efficient software release cycles to be performed.

In some cases, the running of a batch file creation service may be performed by one or more computing devices on an organization's computing network, such as by the file generation server 140. For example, the batch file creation module 150 may be used to generate a file in a specified format (e.g., a spreadsheet format, or the like) with usable data based on inputs received at the batch file creation module 150. The file conversion module 160 may be used to convert a batch file created by the batch file creation module 150 into a different file format such as a text-based data file (“.dat”) (e.g., a file with entries separated by a delimiter, such as a ‘|’ character, a “,” character, a “;” character, or the like) that may be used at the input 113 of the software test module 111. In some cases, the file conversion module 160 may be used for “reverse” conversion of a text-based data file (e.g., a file with character-based entry delimiters) to a batch file in spreadsheet format. The file check module may read a file (e.g., a batch file, a converted file or the like) to verify data and/or expressions included in the file. The file loader module 180 may upload and/or prepare a selected converted file for use as input 113 to the software test module 111.

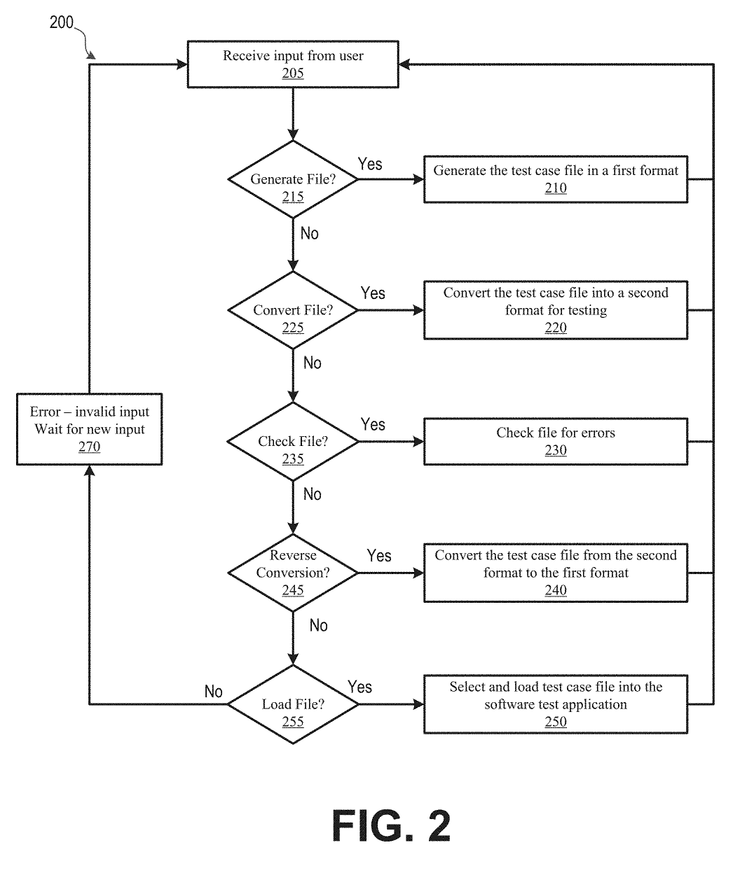

FIG. 2 shows an illustrative flow diagram of a method 200 that may be performed by the file generation server 140 according to aspects of the disclosure. At 205, the file generation server 140 may receive an input, sent via the network 115, from the user device 110. The input may be entered by a user in response to selections displayed on a user interface screen, such as the user interface screen 600 shown in FIG. 6. The user interface screen 600 may be displayed by the user interface device 128 of the user device 120, such as in a browser screen, an application screen, and/or the like. The user may enter a choice of action using one or more user inputs provided in the user interface screen, such as a “create batch file” button 610, a “convert file” button 620, a “check” file button 630, a “reverse” conversion button 640 and/or a “load” file button 650 and/or with other inputs provided to the user. When the user selects an action via one of the buttons 610-650, the user device 120 may communicate the selected user input via the network 115 to the file generation server 140 for processing.

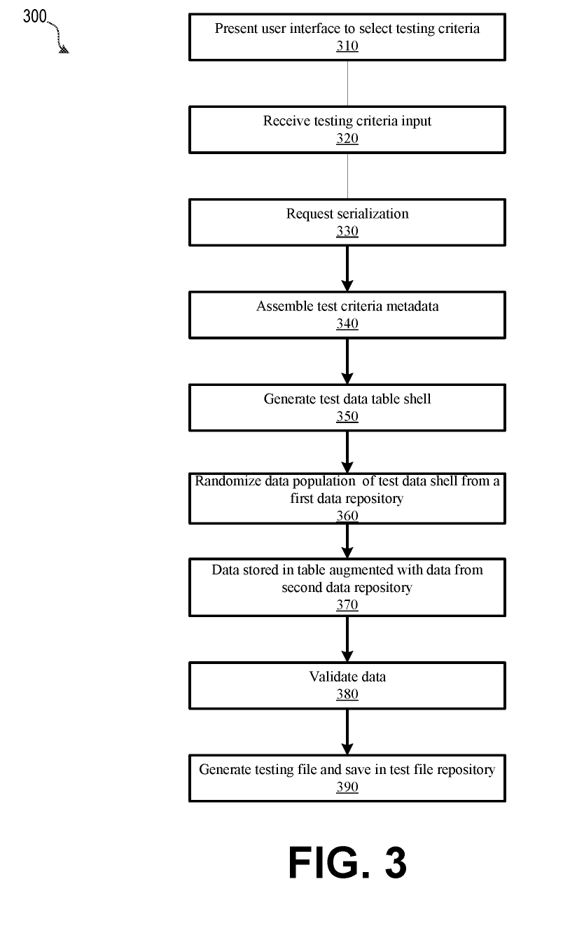

At 215, the file generation server 140 may process the input received from the user device to determine whether file creation selection was made. If not, the file generation server 140 may further analyze the input at 225. If so, at 210, in response to the received input, the file creation module 150 of the file generation server 140 may process instructions stored in memory to generate a batch file for use in testing a software application, such as by using the illustrative method shown in FIG. 3. FIG. 3 shows an illustrative method 300 that may be performed by the file creation module 150 of the file generation server to generate a batch file according to aspects of this disclosure.

In response to the received input to generate a batch file, the file generation module, at 310, may generate or otherwise cause a file configuration user interface screen to be presented to a user, such as at a display of the user interface device 128. In some cases, the user interface screen may be hosted on an application server, such as the file generation server 140 and communicated via the network to the user device 110. FIG. 7 shows an illustrative user interface screen 700 that may be presented to a user to facilitate file configuration and/or user entry of information used to generate a batch file. For example, the illustrative user interface screen 700 for entering user specification information may include a plurality of fields to customize desired testing parameters, such as a number of records to be tested, a number of test characteristics, a testing environment, and/or one or more custom attributes that may be used to test specific functionality of the software application or service to be tested by the software test module 111. In some cases, a button may be included to prefill fields such that a previously run or pre-configured test may be used in the batch file creation process. In an illustrative example, a user may input a desired amount of requirements to be used to generate a file, such as specifying a number of records to be generated in the file, specifying a characteristic of the software application or service (e.g., customized marketing information, customized order entry, customized user display information, and the like), and/or specifying a number of custom attributes to be included in the test records (e.g., a user attribute, a user permission level, user functionality of the application, and the like). Once complete, the user may submit the specification and the batch file creation information is communicated to the batch file creation module 150 via the network 115, at 320.

At 330, the batch file creation module 150 may process the batch file creation information to generate a plurality of test parameters, such as by serializing the data. For example, the batch file creation module 150 may analyze the batch file creation information and based on the analysis, may construct a data structure (e.g., a table, an array of string arrays, and the like) based on the user requirements, where a maximum size of the data structure (e.g., a “request skeleton”) may correspond to a number of records to be tested as specified by the user. The definition for the data (e.g., string array, and the like) in each data structure element may be defined based on the characteristics and attributes as defined in the received batch file creation information. Once the data structure creation is complete, test metadata may be assembled to facilitate the file creation process.

At 340, the batch file creation module 150 may perform a metadata inquiry. In the metadata inquiry, the batch file creation module may query a lookup table for information corresponding to the created data structure, such as for header row names, designation numbers for key-value pairs, regular expressions for valid data and the like. This metadata may then be included in a metadata element of the data structure.

At 350, based on the metadata stored in the metadata element of the data structure and the format of the data structure built based on the received user specification, the batch file creation module 150 may generate a file shell having a format associated with a desired file type, such as a spreadsheet format. This file shell may be used as the basis for the batch file to be output by the batch file creation module 150, when completed.

At 360, the batch file creation module 150 may perform a first iteration that may populate at least a portion of cells in the file shell with random values retrieved from a first data repository (e.g., the data repository 132), such as by using the metadata associated the data structure. In an illustrative example, the first data repository 132 may store information corresponding to a plurality of simulated users and/or customers of the organization, where the information includes simulated data that would be used with the software application or service under test during normal operation, such information may include name information, address information, financial account information, user preference information, contact information, and the like.

At 370, once the file shell has been populated with the randomized data retrieved from the first data repository 132, the batch file generation module 150 may perform a second iteration to augment the data retrieve from the first data repository with data retrieved from a second data repository, such as the data repository 134, based on the metadata associated with the data structure. In some cases, the data retrieved from the second data repository may be retrieved randomly from the data repository. In some cases, the data from the second data repository 134 may be retrieved based on information retrieved from the first data repository. Once the data is retrieved form the second data repository 134, the batch file creation module 150 may augment the data retrieved from the first data repository 132 and stored in each cell of the shell file with the information retrieved from the second data repository 134. In the illustrative example, the second data repository may store information corresponding to information that may be sent to a user concerning the product or service provided by the organization, such as marketing information, sales information, and/or the like. In some cases, the second information may be dependent upon characteristics of the user to which the information may be sent, such as by making a credit card rate dependent upon a financial characteristic of the person retrieving the offer.

At 380, the batch file creation module 150 may process the merged data stored in the file shell to verify an allowable configuration. In some cases, the validation of the data may be used to insert invalid data or allow invalid data to remain in the batch file, such that an error reaction of the software under test by the software test module 111 can be verified. The validation check may be performed on a cell by cell basis, or as a series of cells, such that data logic between cells may be validated to avoid invalid data scenarios, unless otherwise used for testing error handling functionality or the like.

At 390, the batch file generation module 150 may generate a file based on the completed shell file and store the file, such as in the file repository 190, in a desired file format (e.g., a spreadsheet data format, and the like). In some cases, the completed batch file may be stored locally, stored at the remote user device, or a copy may be stored at a number of different locations.

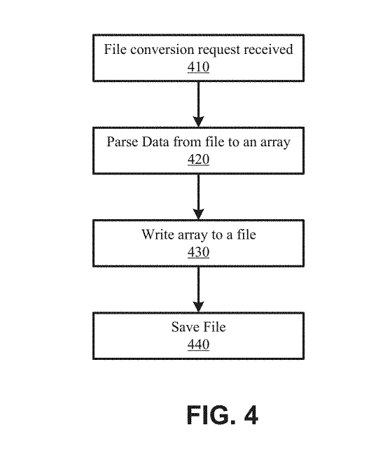

Returning to FIG. 2 at 225, the file generation server 140 may process the input received from the user device to determine whether file conversion selection was made. If not, the file generation server 140 may further analyze the input at 235. If so, at 220, the file conversion module 160 of the file generation server 140 may process the file conversion request, such as by using method of file conversion as shown in the illustrative example of FIG. 4. FIG. 4 shows an illustrative method 400 that may be performed by the file conversion module of the file generation server 150 to convert a file from a first format to a second format according to aspects of this disclosure. For example, the file conversion module 150 may receive the file conversion request received from the user device via the network, along with a file identifier of the file to be converted at 410. At 420, the file conversion module 160 may parse data form the file into an internal array. At 430, the data stored in the array may be written to a file in the desired format, and the file may be saved at 440, such as at the file repository 190, at the user device 110 and/or in multiple locations. In an illustrative example, at the user device 110, via one or more user interface screens 125, the user may choose a file to convert. In the user interface screen, the system may filter the available files stored in the file repository to list only those stored in a spreadsheet format. The file conversion module 160 may read each cell in the spreadsheet formatted batch file and write the files contents into an array. The file conversion module 160 may then use a delimiter (e.g., the “|” char, or the like) to identify each cell in a row of the batch file, where each row may be delimited as a new line in the array (e.g., a string element of a string array, or the like) or data structure. The file conversion module 160 may then generate a text file with each delimited row of the spreadsheet represented as a new line in the text file, and the text file may be saved for future use, such as in the file repository 190.

At 235, the file generation server 140 may process the input received from the user device to determine whether a check file selection was made. If not, the file generation server 140 may further analyze the input at 245. If so, at 230, the file check module 170 of the file generation server 140 may receive an indication of a file to validate via the network from the user device 110, where the file is in a specified format (e.g., a spreadsheet format, a text format, or the like). The file check module 170 may check the one or more databases and query a lookup table for each cell, such as a cell of the specified batch file. Each cell may have an associated key-value pair with the lookup table. The keys in the lookup table will match the keys in the excel document and will be used to validate regular expressions from the lookup table when matched. The file check module 170 may provide a file output and/or a user interface screen displaying the results of the verification process. If errors are found, the user is presented with an identified row and/or cell having an error. If no errors are found, the user is notified of that.

At 245, the file generation server 140 may process the input received from the user device to determine whether a reverse file conversion selection was made. If not, the file generation server 140 may further analyze the input at 255. If so, at 240, the file conversion module 160 of the file generation server 140 may receive an indication of a file to convert in a specified format (e.g., a text file, a “.DAT” file, and the like). The file conversion module 160 may load the file from the file repository 190, such as by using a text reader, or other such program, and identifying the location of each delimiter and/or carriage return is located in the file. The file conversion module 160 may then generate a file in a spreadsheet format, where each cell corresponds to a cell demarcated by the delimiter and each row identified by the carriage return. Once complete, the generated file may be saved in the file repository 190 in a spreadsheet format and/or communicated to the user device 110.

At 255, the file generation server 140 may process the input received from the user device to determine whether a load file selection was made. If not, the file generation server 140 may issue an error and/or wait for a new input at 270. If so, at 240, the file load module 180 of the file generation server 140 may receive an indication of a file to convert and/or load. If a file is to be converted, such as a file in a spreadsheet format, the file conversion module 160 may convert the file into a format capable of being used by the software test module 111. The file load module 180 may read the selected file (e.g., text file, “.DAT” file, and the like) and identify any application reference numbers associated with the file and store the identified application reference numbers in a memory location for later use. The file load module 180 may then transfer the file to the test sever 110, such as to a temporary directory in the memory 114. A bash file writer of the file loader module 180 may generate a bash file using the application reference numbers that are each associated with a name of an image, such that the software test module may utilize a unique application reference number for each image. The file load module 180 may transfer the bash file into the temporary directory in the memory 114 of the test server and may then initiate a bash process, creating images and directories in a specified memory location such as a memory location associated with the input 113 of the software test module, or a memory location in the memory 114. The file load module 180 may then send a verification message to the user that the file load process has completed.

In some cases, the file generation server and/or other computing devices may include one or more open-source frameworks for specifically programming the file generation server 140 to implement and/or create one or more of the batch file creation module 150, file conversion module 160, file check module 170, file loader module, the file repository 190 and/or the like. The file generation server 140 may provide a simple and elegant solution to optimizing testing processes in generating an optimized batch test file, which are designed in a way where we have little maintenance for future changes and allows for testing repeatability and robustness. The file generation server 140 provides an efficient and fast method to generate and manage test files that allows for the test server 110 to be utilized more efficiently, such that the test server 110 may be utilized more with less downtime as applications can be tested on an as needed basis without waiting for test cases to be developed. The file generation server may include a regular expression lookup table, that may be stored in the memory 144, the data management server 130 or the like, and which is independent to all other applications. The regular expressions may be used simply for data validations for any user of the tool. An automation web service may be used with or without manual testing by the test server 110. The file generation server 140 and the batch file creation service may be used in the form of a web service. The file generation server 140 and the batch file creation service may be capable of separating manual/automation testing and responds accordingly simply through the usage of a flag.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally, or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

1. A system comprising:
a file creation computing device comprising:
a processor; and
a non-transitory memory device storing instructions, that when executed by the processor, cause the file creation computing device to:
receive, via a user interface, criteria for testing a software application;
generate a data structure corresponding to the criteria for testing the software application, wherein a format of the data structure corresponds to a software test case associated with the criteria;
retrieve and store in the data structure, based on the format of the data structure and the criteria, a first data set randomly selected from a first data repository, the first data set comprising user information;
merge, based on the format of the data structure, metadata associated with the data structure, and the criteria, a second data set retrieved from a second data repository with the first data set stored in the data structure;
validate a merged data set to ensure each element of the data structure based on a lookup table of valid combinations of data contained in the first data repository and data contained in the second data repository; and
generate a batch test file using the data structure storing a merged data set including the first data set merged with the second data set.

2. The system of claim 1, wherein the instructions, when executed by the processor, cause the file creation computing device to:
transmit, via a network to a user interface, a first user interface screen including a plurality of inputs each corresponding to file creation command of a plurality of commands;
receive, via the network from the user interface, an input corresponding to a selected command of the plurality of commands; and
transmit, via the network to the user interface, a second user interface screen including a plurality of fields corresponding to the criteria for testing the software application.

3. The system of claim 2, comprising a user device including the user interface.

4. The system of claim 2, wherein a plurality of commands comprises one or more of a create batch file command, a file conversion command, a file check command, a reverse file conversion command, and a load file command.

5. The system of claim 1, wherein the criteria for testing the software application includes at least one of a maximum number of records for testing, a characteristic of the first data set, a characteristic of the second data set, an identifier of a testing environment in which the software application is to be tested, one or more attributes of the first data set, and one or more attributes of the second data set.

6. (canceled)

7. (canceled)

8. The system of claim 1, wherein the instructions, when executed by the processor, cause the file creation computing device to:
receive, from the user interface, an indication of a batch file to be tested;
parse the batch file to be tested and load the data into an array; and
generate a converted batch file in a format associated with a testing environment.

9. The system of claim 8, wherein the batch file is formatted in a spreadsheet format and the converted batch file is formatted in a delimiter-based text format.

10. An apparatus comprising:
a processor; and
a non-transitory memory device storing instructions, that when executed by the processor, cause the apparatus comprising a file creation server to:
receive, via a user interface, criteria for testing a software application;
generate a data structure corresponding to the criteria for testing the software application, wherein a format of the data structure corresponds to a software test case associated with the criteria;
retrieve and store in the data structure, based on the format of the data structure and the criteria, a first data set randomly selected from a first data repository, the first data set comprising user information;
merge, based on the format of the data structure, metadata associated with the data structure, and the criteria, a second data set retrieved from a second data repository with the first data set stored in the data structure;
validate a merged data set to ensure each element of the data structure based on a lookup table of valid combinations of data contained in the first data repository and data contained in the second data repository; and
generate a batch test file using the data structure storing a merged data set including the first data set merged with the second data set.

11. The apparatus of claim 10, wherein the instructions, when executed by the processor, cause the apparatus to:
transmit, via a network to a user interface, a first user interface screen including a plurality of inputs each corresponding to file creation command of a plurality of commands;
receive, via the network from the user interface, an input corresponding to a selected command of the plurality of commands; and
transmit, via the network to the user interface, a second user interface screen including a plurality of fields corresponding to the criteria for testing the software application.

12. The apparatus of claim 11, wherein the plurality of commands comprises one or more of a create batch file command, a file conversion command, a file check command, a reverse file conversion command, and a load file command.

13. The apparatus of claim 11, wherein the criteria for testing the software application includes at least one of a maximum number of records for testing, a characteristic of the first data set, a characteristic of the second data set, an identifier of a testing environment in which the software application is to be tested, one or more attributes of the first data set, and one or more attributes of the second data set.

14. (canceled)

15. (canceled)

16. The apparatus of claim 10, comprising: wherein the instructions, when executed by the processor, cause the file creation server to:
receive, from the user interface, an indication of a batch file to be tested;
parse the batch file to be tested and load the data into an array; and
generate a converted batch file in a format associated with a testing environment.

17. The apparatus of claim 16, wherein the batch file is formatted in a spreadsheet format and the converted batch file is formatted in a delimiter-based text format.

18. A method to generate a batch file for use in testing one of a software application or service, comprising:
receiving, via a user interface, criteria for testing a software application;
generating a data structure corresponding to the criteria for testing the software application, wherein a format of the data structure corresponds to a software test case associated with the criteria;
retrieving and storing in the data structure, based on the format of the data structure and the criteria, a first data set randomly selected from a first data repository, the first data set comprising user information;
merging, based on the format of the data structure, metadata associated with the data structure, and the criteria, a second data set retrieved from a second data repository with the first data set stored in the data structure;
validating a merged data set to ensure each element of the data structure based on a lookup table of valid combinations of data contained in the first data repository and data contained in the second data repository; and
generating a batch test file using the data structure storing a merged data set including the first data set merged with the second data set.

19. The method of claim 18, comprising:
receiving, from the user interface, an indication of a batch test file to be tested;
parsing the batch test file to be tested and load the data into an array; and
generating a converted batch file in a format associated with a testing environment, wherein the batch file is formatted in a spreadsheet format and the converted batch file is formatted in a delimiter-based text format.

20. The method of claim 19, comprising:
transmitting, via a network to a user interface, a first user interface screen including a plurality of inputs each corresponding to file creation command;
receiving, via the network from the user interface, an input corresponding to a selected command; and
transmitting, via the network to the user interface, a second user interface screen including a plurality of fields corresponding to the criteria for testing the software application.
